(19) United States
(12) Patent Application Publication
(10) Pub. No.: US 2026/0242983 A1
(43) Pub. Date: Aug. 20, 2026

(54) DURABLE AND BREATHABLE TEXTILE FABRIC AND PROCESS FOR MANUFACTURING THE SAME

(71) Applicant: UndrDog, LLC, Cape Coral, FL (US)

(72) Inventor: Charles Gregory, Cape Coral, FL (US)

(21) Appl. No.: 19/539,265

(22) Filed: Feb. 13, 2026

Related U.S. Application Data
(60) Provisional application No. 63/760,257, filed on Feb. 19, 2025.

(51) Int. Cl. D01F 2/06; B32B 27/12; D04B 1/24

(52) U.S. Cl. CPC D01F 2/06; B32B 27/12; D04B 1/24

(57) ABSTRACT

A textile fabric comprises a knitted structure of blended yarn containing 48-54% mechanically softened hemp fibers, 28-34% regenerated bamboo fibers, and 16-22% organic cotton fibers by weight. The mechanically softened hemp fibers have reduced linear mass density enabling exceptional softness despite high hemp content. The fabric achieves softness comparable to cotton fabrics while maintaining superior durability and environmental responsibility.

### CROSS-REFERENCE TO RELATED APPLICATIONS

This application claims the benefit of priority under 35 U.S.C. § 119(e) to U.S. Provisional Patent Application No. 63/760,257, filed Feb. 19, 2025, entitled "DURABLE AND BREATHABLE TEXTILE FABRIC AND PROCESS FOR MANUFACTURING THE SAME," the entire contents of which are incorporated herein by reference.

### FIELD OF THE INVENTION

The present invention relates generally to textile fabrics and related manufacturing processes. More particularly, the invention relates to a durable and breathable textile fabric comprising a blend of natural fibers and a process for manufacturing the same that eliminates the need for harmful synthetic additives and chemical finishing agents.

### BACKGROUND OF THE INVENTION

Traditional textile manufacturing processes have long relied on synthetic materials and chemical treatments to achieve desired performance characteristics in fabrics. Conventional fabrics often employ synthetic fibers, PFAS (per- and polyfluoroalkyl substances), microplastics, and other harmful finishing agents to enhance properties such as water resistance, durability, and shape retention. However, these synthetic materials and chemical treatments present significant concerns for both human health and environmental sustainability. PFAS compounds, commonly known as "forever chemicals," persist in the environment and bioaccumulate in living organisms.

Microplastics shed from synthetic fabrics contribute to widespread environmental contamination. Many chemical finishing agents contain substances that can cause skin irritation, allergic reactions, and other adverse health effects in sensitive individuals.

Natural fiber fabrics, while generally safer for human health and the environment, have historically struggled to achieve the performance characteristics of their synthetic counterparts. Cotton fabrics, while breathable and comfortable, often lack sufficient durability for demanding applications. Hemp fabrics offer excellent strength but may sacrifice softness and comfort. Bamboo-derived fabrics provide good breathability but may lack the structural integrity required for long-term wear.

Previous attempts to create high-performance natural fiber fabrics have typically involved either: (a) blending natural fibers with synthetic materials to compensate for performance limitations, thereby reintroducing the environmental and health concerns associated with synthetics; or (b) applying chemical finishing treatments to natural fabrics, which similarly undermines the environmental and health benefits of using natural fibers. Furthermore, conventional textile manufacturing processes often fail to optimize fiber blends and processing parameters to achieve synergistic performance benefits. The selection of fiber ratios, knitting patterns, dyeing techniques, and finishing processes significantly impacts the final fabric characteristics, yet many manufacturers employ standardized approaches that do not fully leverage the unique properties of different natural fibers.

Accordingly, there exists a need in the art for a textile fabric that combines natural fibers in a manner that achieves superior durability and breathability without relying on synthetic materials or harmful chemical treatments. There is also a need for a manufacturing process that can produce such fabrics in a commercially viable and environmentally responsible manner while maintaining consistent quality across production batches.

### BRIEF SUMMARY OF THE INVENTION

The present invention, in an embodiment, provides a textile fabric that achieves exceptional softness despite high hemp content through a specific blend of mechanically softened hemp fibers, regenerated bamboo fibers, and organic cotton fibers in a knitted structure. In one embodiment, the textile fabric comprises a knitted structure of blended yarn containing 48-54% mechanically softened hemp fibers, 28-34% regenerated bamboo fibers, and 16-22% organic cotton fibers by weight, wherein the fabric has a weight of 250-320 grams per square meter. In an embodiment, the textile exhibits residual shrinkage of less than 5% after washing. In a specific embodiment, the blended yarn comprises 51% mechanically softened hemp, 31% regenerated bamboo, and 18% organic cotton. In an embodiment, the textile is free of PFAS, microplastics, and synthetic finishing agents while achieving softness comparable to 100% cotton fabrics.

### DETAILED DESCRIPTION

As noted, the blended yarn comprises 48-54% mechanically softened hemp fibers by weight in one embodiment. In a particular embodiment, the hemp may comprise 51% by weight of the fibers, but alternative embodiments include 50%, 52%, 48%, or 53% hemp content by weight. Broader ranges encompass 45-55% hemp content, by weight, allowing optimization for specific applications requiring different balances of durability and softness. The mechanically softened hemp fibers have reduced linear mass density, in some embodiments, compared to conventional hemp, up to a 20-40% reduction that enables the fibers to blend more uniformly and contribute to fabric softness rather than stiffness.

In an embodiment, the regenerated bamboo fiber content ranges from 28-34% by weight. In a particular embodiment, the bamboo composition is 31% by weight of the fiber blend, with alternative embodiments including 30%, 32%, 29%, or 28% bamboo content. Broader ranges encompass 25-35% bamboo content. The bamboo fibers may be produced through regenerated cellulose processing (viscose or lyocell). In an embodiment, the bamboo fibers exhibit a silky hand feel and excellent moisture absorption properties.

In an embodiment, the organic cotton fiber content ranges from 16-22% by weight. In a particular embodiment, the cotton comprises 18% by weight of the fiber blend, with alternative embodiments including 20%, 21%, or 19% cotton content. Broader ranges encompass 15-25% cotton content.

In one embodiment of the manufacturing method, the three fiber types are blended at the sliver stage. In an embodiment, the fibers are processed through multiple drawing operations (for example, 2-4 passages). In an embodiment, these steps help to achieve homogeneous distribution throughout the yarn. In an embodiment, the yarn has a blend uniformity variation below 3%, or preferably below 2%. This sliver-stage blending, as opposed to raw fiber blending, ensures intimate fiber mixing and consistent properties throughout the fabric structure.

The blended yarn is formed into a knitted structure, which provides superior stretch, recovery, and comfort compared to woven constructions. The knitted structure is produced on circular knitting machines to create seamless tubular fabric. In one embodiment, the fabric has a single jersey knit construction characterized by interlocking loops forming a smooth face and distinct back. In another embodiment, rib knit construction with alternating knit and purl wales provides enhanced elasticity and recovery. In a further embodiment, interlock construction with two sets of interlocking loops provides enhanced dimensional stability, opacity, and a smooth surface on both sides.

The knitted structure exhibits controlled stitch density that contributes to the fabric's performance characteristics. The stitch formation exhibits uniform loop size, consistent tension throughout the structure, and balanced dimensional properties in both machine and cross-machine directions.

Alternative knitted constructions include single jersey with lycra plating incorporating 2-5% spandex for added stretch recovery, French terry construction with loop pile on the interior surface providing enhanced comfort and moisture absorption, pique knit with textured surface enhancing breathability and visual interest, or fleece construction with mechanically raised interior surface for thermal insulation.

Alternative fiber blend compositions include 50% hemp, 32% bamboo, 18% cotton; 52% hemp, 30% bamboo, 18% cotton; 51% hemp, 29% bamboo, 20% cotton; 48% hemp, 31% bamboo, 21% cotton; or 53% hemp, 28% bamboo, 19% cotton, each providing slightly different balances of durability, softness, and performance characteristics while maintaining the core advantages of the invention.

### Method

In an embodiment, industrial hemp fibers are retted (for example, via water retting, dew retting, or enzymatic retting), followed by decortication using roller-based or hammer mill decorticators. In an embodiment, decorticated fibers are then passed through breaking rolls that flex and separate fiber bundles. Exposure to mechanical beating may disrupt pectin bonding and/or scutching. In one embodiment, these processes reduce average linear mass density by 20-40% as compared to unprocessed decorticated hemp. The softened fibers may then undergo cleaning through air blowing and screening, or alternatively through mild alkaline wash (for example, 1-3% sodium hydroxide at 80-100°C for 30-60 minutes) followed by neutralization and drying.

In an embodiment, bamboo fibers are produced through regenerated cellulose processing wherein bamboo culms are chipped, subjected to alkaline treatment to extract cellulose, dissolved in a solvent system, extruded through spinnerets, and regenerated to form continuous filaments. Alternatively, lyocell-processed bamboo or a blend of mechanical and regenerated bamboo (10-30% mechanical, 70-90% regenerated) may be employed.

In an embodiment, organic cotton fibers are obtained through ginning and cleaning of organically cultivated cotton. In an embodiment, staple lengths may be 28-32mm, 32-36mm, or 36-42mm. Alternative cotton types include Pima (35-42mm), Egyptian (33-39mm), or Supima (35-40mm) organic cotton.

In an embodiment, each fiber type is opened and carded separately, with hemp processed on specialized bast fiber cards with coarser clothing and bamboo/cotton processed on standard cards. As noted above, the blending step occurs at the sliver stage by feeding individual fiber slivers into a draw frame in predetermined proportions: 51% hemp, 31% bamboo, 18% cotton in an embodiment; 50% hemp, 30% bamboo, 20% cotton; or within ranges of 45-55% hemp, 25-35% bamboo, 15-25% cotton. Alternative ranges include 48-54% hemp, 28-34% bamboo, 16-22% cotton. Multiple drawing processes (2-4 passages) may be used to ensure homogeneous distribution with coefficient of variation below 3%, or preferably below 2%.

In this embodiment, blended slivers are converted into rovings, then spun into yarn using ring spinning, compact spinning, open-end rotor spinning, or air-jet spinning. In an embodiment, the yarn is processed on circular knitting machines to produce seamless tubular fabric in single jersey, rib, or interlock construction. Alternative constructions include French terry, pique, or fleece. Greige fabric weight ranges from 220-280 GSM, 180-240 GSM for lightweight, or 260-340 GSM for heavyweight applications.

In some embodiments, the knitted fabric undergoes batch dyeing. Low-impact techniques include reactive dyes with low-salt methods, natural plant-derived dyes, or fiber-reactive dyes with reduced alkali. In an embodiment, washing then removes excess dye. In an embodiment, the fabric undergoes compaction. This may include mechanically compressing the fabric in the length direction, reducing fabric length by 8-15% while increasing weight per unit area by 10-18%. Compaction may be performed using palmer-type or rubber blanket systems that apply mechanical pressure to pre-shrink the fabric and densify the knit structure, achieving residual shrinkage of less than 5%, preferably less than 3%, after washing. This mechanical compaction process may provide dimensional control through physical compression of the knitted loops. Following compaction, the fabric may undergo heat setting at controlled temperatures to further stabilize the fiber structure and enhance shape retention.

The finished fabric weighs 250-320 GSM in an embodiment, with alternatives at 260-300 GSM, 220-280 GSM for medium weight, 150-220 GSM for lightweight, 280-350 GSM for medium-heavy, or 340-420 GSM for heavyweight applications.

In an embodiment, the finished fabric is then relaxed under controlled conditions. In an embodiment, this comprises laying flat at 20-25°C and 60-70% relative humidity for 12-24 hours, or through mechanical relaxation at 80-100°C with minimal tension. The relaxed fabric is spread and cut according to CAD patterns then assembled. In an embodiment, the assembled garments undergo washing, drying, and steam pressing, to achieve smooth appearance and dimensional stability.

### Characteristics

A distinguishing characteristic of the fabric is exceptional softness despite hemp content exceeding 45% by weight. Conventional hemp fabrics at this content level exhibit significant stiffness and roughness that limit comfort and wearability. The present fabric achieves softness comparable to 100% organic cotton fabrics through the combination of mechanically softened hemp fibers with reduced linear mass density, the inherent softness of regenerated bamboo fibers, homogeneous sliver-stage blending, compaction that densifies the knit structure, and heat setting that stabilizes the fiber structure, both contributing to surface smoothness without creating harshness.

While not wishing to be bound by theory, it is believed that the mechanical softening of hemp fibers, wherein the fibers are processed through breaking rolls, mechanical beating, or scutching to reduce linear mass density by 20-40%, enables this unexpected softness. The softened hemp fibers blend more intimately with the bamboo and cotton components and contribute flexibility rather than rigidity to the final fabric structure. Conventional textile knowledge teaches that hemp fibers impart significant stiffness to fabrics, with industry practice typically limiting hemp content to below 30% in blended fabrics intended for comfortable next-to-skin wear. Fabrics containing 51% hemp would ordinarily exhibit unacceptable stiffness and roughness that prevent their use in t-shirts, activewear, and similar comfort-critical applications. However, the present invention achieves softness comparable to 100% organic cotton fabrics through the synergistic combination of mechanical softening of the hemp fibers prior to blending, precise sliver-stage blending that ensures homogeneous fiber distribution rather than fiber clumping that would create localized stiff areas, and dimensional stabilization and/or compaction. This combination of controlled fiber preparation, precise blending methodology, and optimized finishing processes produces a fabric hand feel that contradicts the expected performance of high-hemp textiles, enabling commercial applications previously considered unsuitable for hemp-dominant fiber compositions.

The fabric is free of PFAS (per- and polyfluoroalkyl substances), microplastics, and harmful synthetic finishing agents, making it suitable for sensitive skin applications and environmentally conscious consumers. The fabric biodegrades naturally at end of life, with the natural fiber composition decomposing without releasing persistent pollutants.

What is claimed is:

1. A textile fabric comprising a knitted structure of blended yarn, the blended yarn comprising:48-54% mechanically softened hemp fibers by weight;28-34% regenerated bamboo fibers by weight; and16-22% organic cotton fibers by weight, wherein the fabric has a weight of 250- 320 grams per square meter.

2. The textile fabric of claim 1, wherein the blended yarn comprises 51% mechanically softened hemp, 31% regenerated bamboo, and 18% organic cotton by weight.

3. The textile fabric of claim 1, wherein the fabric is free of PFAS, microplastics, and synthetic finishing agents.

4. The textile fabric of claim 1, wherein the fabric is a seamless tubular knitted fabric produced by circular knitting.

5. The textile fabric of claim 1, comprising 50% mechanically softened hemp fibers by weight, 30% regenerated bamboo fibers by weight, and 20% organic cotton fibers by weight.

6. A garment comprising the textile fabric of claim 1.

7. A method for manufacturing a textile fabric comprising:retting, decorticing, and mechanically softening industrial hemp fibers;processing bamboo through regenerated cellulose methods and cutting into staple fibers;ginning organic cotton fibers;
separately opening and carding each fiber type;
blending the fibers at a sliver stage in a ratio of 48-54% mechanically softened hemp, 28-34% regenerated bamboo, and 16-22% organic cotton by weight;
applying multiple drawing processes to achieve homogeneous fiber distribution;
converting the blended sliver into roving and spinning into yarn with regulated twist and tension; and
processing the yarn on circular knitting machines to produce seamless tubular knitted fabric while maintaining uniform tension, stitch density, and structural integrity.

8. The method of claim 7, further comprising batch dyeing the knitted fabric using a low-impact dye system.

9. The method of claim 7, further comprising washing the dyed fabric to remove excess dye and impurities.

10. The method of claim 7, wherein the fiber blend comprises 51% mechanically softened hemp, 31% regenerated bamboo, and 18% organic cotton by weight.

11. The method of claim 7, wherein mechanical softening comprises passing hemp fibers through breaking rolls that flex and separate fiber bundles.

12. A textile fabric produced by the method of claim 7.

13. The method of claim 7, wherein the finished fabric has a weight between approximately 150-350 grams per square meter.

14. The method of claim 7, further comprising compacting the knitted fabric by mechanically compressing the fabric in the length direction to reduce fabric length by 8- 15%.

15. A method for manufacturing a textile fabric comprising:
providing mechanically softened hemp fibers, regenerated bamboo staple fibers, and organic cotton fibers;
separately opening and carding each fiber type to produce individual fiber slivers;
blending the fiber slivers at a sliver stage in a ratio of 48-54% mechanically softened hemp, 28-34% regenerated bamboo, and 16-22% organic cotton, each by weight;
applying at least one drawing process to the blended sliver to achieve homogeneous fiber distribution;
spinning the blended sliver into yarn; and
circular knitting the yarn to produce seamless tubular knitted fabric.

16. The method of claim 15, wherein the fiber blend comprises 51% mechanically softened hemp, 31% regenerated bamboo, and 18% organic cotton by weight.

17. The method of claim 15, further comprising batch dyeing the knitted fabric using a low-impact dye system.

18. The method of claim 15, further comprising washing the dyed fabric to remove excess dye and impurities.

19. The method of claim 15, further comprising heat setting the compacted fabric at a controlled temperature to stabilize the fiber structure.
